(19) United States
(12) Patent Application Publication
(10) Pub. No.: US 2020/0291271 A1
(43) Pub. Date: Sep. 17, 2020

(54) RELEASE SHEET

(71) Applicant: LINTEC Corporation, Itabashi-ku (JP)

(72) Inventors: Koji MIYAMOTO, Tsukuba-shi (JP); Atsushi KUROKAWA, Saitama-shi (JP); Masayasu KAMO, Warabi-shi (JP)

(73) Assignee: LINTEC Corporation, Itabashi-ku (JP)

(21) Appl. No.: 16/332,610

(22) PCT Filed: Sep. 11, 2017
(86) PCT No.: PCT/JP2017/032713

§ 371 Date: Mar. 12, 2019

(30) Foreign Application Priority Data
Sep. 16, 2016 (JP) 2016181832

(51) Int. Cl. C09J 7/40; C09J 7/38; C09J 7/50

(52) U.S. Cl. CPC C09J 7/401; C09J 7/38; C08K 5/34922; C09J 7/403; C09J 7/50; C09J 7/405

(57) ABSTRACT

Provided is a release sheet including a substrate and a release layer, wherein the release layer is composed of a crosslinked product of a resin composition containing a polyolefin resin having a reactive functional group and a crosslinking agent; and the content of the polyolefin resin having a reactive functional group is from 50 to 90% by mass, and the content of the crosslinking agent is from 7 to 45% by mass, relative to the whole amount of the resin composition.

### TECHNICAL FIELD

The present invention relates to a release sheet.

### BACKGROUND ART

In general, a release sheet is one obtained by coating a release agent composition containing a reactive compound on a substrate, such as a paper, a plastic film, and a polyethylene laminated paper, followed by curing to provide a release layer and is, for example, widely used as a protective sheet for a pressure sensitive adhesive body, such as a pressure sensitive adhesive sheet, a casting film for preparation of a resin sheet, a casting film for film formation of a ceramic green sheet, and a casting film for synthetic leather production.

As for the release sheet, silicone-based sheets containing, in a release layer, a silicone compound, such a silicone resin, a siloxane, and a silicone oil, are widely used. The silicone compound may occasionally migrate into a surface coming into contact with a release layer of a release sheet, such as a pressure sensitive adhesive sheet and a resin sheet, and furthermore, after migration, it may gradually vaporize. For that reason, there is a case where when the silicone-based release sheet is used for electronic materials, the silicone compound migrates into an electronic component, thereby causing corrosion or malfunction of the electronic component. In consequence, a release sheet having a release layer composed of a release agent not containing a silicone compound is demanded.

As such a release sheet, there are, for example, proposed release materials (release sheets) having a release agent layer composed of a release agent containing at least a polyolefin, an isocyanate having three or more isocyanate groups in one molecule, and a polyolefin polyol (for example, PTLs 1 to 4). In addition, there is proposed a release film (release sheet) having a release layer composed of a release agent containing a polyolefin elastomer (A) having two or more functional groups capable of reacting with an isocyanate group in one molecule and a compound (B) containing two or more isocyanate groups in one molecule (for example, PTL 5).

### CITATION LIST

### Patent Literature

PTL 1: JP 2011-52207 A

PTL 2: JP 2012-87210 A

PTL 3: JP 2011-94096 A

PTL 4: JP 2012-87211 A

PTL 5: JP 2004-91776 A

### SUMMARY OF INVENTION

### Technical Problem

The release sheet is obtained by coating a coating solution of a resin-containing release agent dissolved in a solvent on a substrate, followed by curing to form a release layer. However, in the release agents described in PTLs 1 to 5, since the polyolefin is a main agent, the solvent resistance is low, so that there is a case where a removable release force (easy peel strength) is not obtained. In addition, in the case of forming a release layer on a substrate by using a low-molecular weight polyolefin as a main agent of the release agent, there is a case where the low-molecular weight polyolefin migrates from the release layer into a surface of a material to be used upon being superimposed on the release layer, thereby causing inconvenience.

In view of the foregoing actual situation, the present invention has been made, and an object thereof is to provide a release sheet which is excellent in solvent resistance and enables a migration amount (hereinafter also referred to as “back migration amount” in this specification) of a low-molecular weight component from a release layer into an adjacent layer thereto to be suppressed.

### Solution to Problem

In order to solve the aforementioned problem, the present inventors made extensive and intensive investigations. As a result, it has been found that the aforementioned problem is solved by a release sheet including a substrate having thereon a release layer composed of a crosslinked product of a resin composition containing a polyolefin resin having a reactive functional group and a crosslinking agent in specified proportions, respectively.

The present invention is one accomplished on a basis of such findings.

Specifically, the present invention provides the following [1] to [8].

[1] A release sheet including a substrate and a release layer, wherein the release layer is composed of a crosslinked product of a resin composition containing a polyolefin resin having a reactive functional group and a crosslinking agent; and the content of the polyolefin resin having a reactive functional group is from 50 to 90% by mass, and the content of the crosslinking agent is from 7 to 45% by mass, relative to the whole amount of the resin composition.
[2] The release sheet as set forth in the above [1], wherein the release layer is provided on the substrate.
[3] The release sheet as set forth in the above [1] or [2], wherein the reactive functional group which the polyolefin resin has is a hydroxy group.
[4] The release sheet as set forth in any of the above [1] to [3], wherein the polyolefin resin has the reactive functional group on both terminals thereof.
[5] The release sheet as set forth in any of the above [1] to [4], wherein the polyolefin resin is a hydrogenated product of polyisoprene.
[6] The release sheet as set forth in any of the above [1] to [5], wherein a number average molecular weight of the polyolefin resin is from 1,500 to 30,000.
[7] The release sheet as set forth in any of the above [1] to [6], wherein the crosslinking agent is a melamine compound.
[8] The release sheet as set forth in the above [7], wherein the melamine compound is at least one selected from the group consisting of a methylolated melamine resin, an iminomethylolated melamine resin, a methylated melamine resin, an ethylated melamine resin, a propylated melamine resin, a butylated melamine resin, a hexylated melamine resin, and an octylated melamine resin.

### Advantageous Effects of Invention

In accordance with the present invention, it is possible to provide a release sheet which is excellent in solvent resistance and enables a migration amount of a low-molecular weight component from a release layer into an adjacent layer thereto to be suppressed.

### BRIEF DESCRIPTION OF DRAWING

FIG. 1 is a cross-sectional view showing one embodiment of the release sheet of the present invention.

### DESCRIPTION OF EMBODIMENTS

### [Release Sheet]

The release sheet of the present invention includes a substrate and a release layer, wherein the release layer is composed of a crosslinked product of a resin composition containing a polyolefin resin having a reactive functional group and a crosslinking agent; and the content of the polyolefin resin having a reactive functional group is from 50 to 90% by mass, and the content of the crosslinking agent is from 7 to 45% by mass, relative to the whole amount of the resin composition.

In this specification, in the case where the resin composition is used in a mode of a solution as mentioned later, the proportion of the “content of the polyolefin resin” or the “content of the crosslinking agent” means a percentage of a mass resulting from exception of the mass of the solvent, namely a percentage of the mass relative to the amount of a non-volatile component.

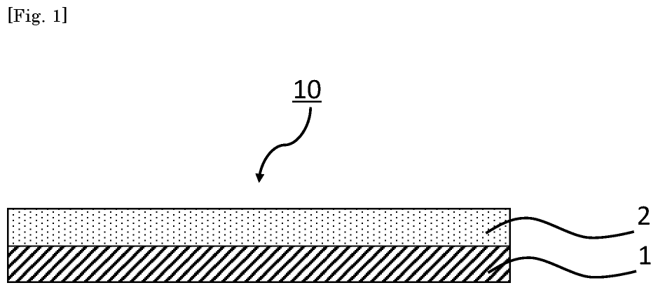

FIG. 1 is a cross-sectional view showing one embodiment of the release sheet of the present invention. A release sheet 10 of FIG. 1 has a substrate 1 and a release layer 2 provided on the substrate 1. The release layer 2 is composed of a crosslinked product of a resin composition containing a polyolefin resin having a reactive functional group and a crosslinking agent.

Non-illustrated other layer, such as a primer layer and an antistatic layer, may be provided between the substrate 1 and the release layer 2.

### (Release Layer)

The release layer in the release sheet of the present invention is a layer composed of a crosslinked product of a resin composition containing a polyolefin resin having a reactive functional group (hereinafter also referred to simply as “polyolefin resin”) and a crosslinking agent in specified proportions, respectively. In view of the fact that the release layer is composed of the aforementioned crosslinked product, the release layer is excellent in solvent resistance and is able to suppress the back migration amount from the release layer into an adjacent layer thereto.

Although the polyolefin resin is not particularly limited so long as it has a reactive functional group, examples thereof include ones obtained by polymerizing one or more α-olefins, such as ethylene, propylene, and 4-methylpenten, and hydrogenated products of a polymer of a diolefin, such as isoprene and butadiene. Of these, from the viewpoint of chemical stability, a hydrogenated product of polyisoprene and a hydrogenated product of polybutadiene are preferred, and a hydrogenated product of polyisoprene is more preferred.

A number average molecular weight of the polyolefin resin is preferably 1,500 to 30,000, more preferably 2,000 to 20,000, and still more preferably 2,500 to 10,000. The number average molecular weight of the polyolefin resin is a value as expressed in terms of polystyrene as measured by the gel permeation chromatography (GPC).

The reactive functional group which the polyolefin resin has is a group capable of reacting with a crosslinking agent as mentioned later. Specifically, examples thereof include a hydroxy group, a carboxy group, an epoxy group, an amino group, an isocyanate group, a thiol group, and a vinyl group, with a hydroxy group being preferred.

The polyolefin resin preferably has the aforementioned reactive functional group on both terminals thereof, and in particular, it preferably has the reactive functional group on only the both terminals of a main chain thereof. This is because in view of the fact that the reactive functional group exists on the both terminals of the main chain, it can be expected that a distance between crosslinking sites becomes long, so that the release sheet has a low release force.

The content of the polyolefin resin relative to the whole amount of the resin composition is 50 to 90% by mass, preferably 55 to 90% by mass, and more preferably 60 to 88% by mass. When the content of the polyolefin resin is less than 50% by mass, the proportion of the crosslinking agent becomes large, and the crosslinking density becomes excessively high, so that there is a concern that the desired easy peeling property is not obtained. When the content of the polyolefin resin is more than 90% by mass, the proportion of the crosslinking agent becomes excessively small, so that there are some concerns that the resin composition cannot be thoroughly crosslinked, the solvent resistance is hardly obtained, and the back migration amount cannot be suppressed.

In the case where a polyolefin (non-reactive polyolefin) which does not react with the crosslinking agent is contained in the resin composition, its content is preferably 10% by mass or less, more preferably 5% by mass or less, and still more preferably 0% by mass.

The crosslinking agent is selected according to the kind of the reactive functional group which the polyolefin resin has and is not particularly limited so long as it is possible to cause a crosslinking reaction.

In the case where the reactive functional group which the polyolefin resin has is a hydroxy group, the crosslinking agent is preferably at least one crosslinking agent selected from the group consisting of a melamine compound, an isocyanate compound, an epoxy compound, an aziridine compound, a hydrazide compound, an oxazoline compound, a carbodiimide compound, a urea compound, a dialdehyde compound, and a metal chelate compound, and more preferably at least one crosslinking agent selected from the group consisting of a melamine compound, an isocyanate compound, and an epoxy compound. Of these, a melamine compound is preferably used from the viewpoint of solvent resistance.

The melamine compound is preferably at least one selected from the group consisting of a methylolated melamine resin, an iminomethylolated melamine resin, a methylated melamine resin, an ethylated melamine resin, a propylated melamine resin, a butylated melamine resin, a hexylated melamine resin, and an octylated melamine resin. Of these, a methylolated melamine resin, an iminomethylolated melamine resin, and a methylated melamine resin are more preferably used, and a methylated melamine resin is still more preferably used.

The content of the crosslinking agent relative to the whole amount of the resin composition is 7 to 45% by mass, preferably 8 to 40% by mass, and still more preferably 10 to 35% by mass. When the content of the crosslinking agent is less than 7% by mass, the crosslinking density is excessively low, so that the solvent resistance is hardly obtained, and there is a concern that the back migration amount cannot be suppressed. When the content of the crosslinking agent is more than 45% by mass, the crosslinking density is excessively high, so that there is a concern that the desired easy peeling property is not obtained.

A blending ratio of the crosslinking agent and the polyolefin resin [(crosslinking agent)/(polyolefin resin)] is preferably 45/50 to 7/90, more preferably 40/55 to 8/90, still more preferably 35/60 to 10/88, and yet still more preferably 35/64 to 10/88.

A total content of the polyolefin resin and the crosslinking agent relative to the whole amount of the resin composition is preferably 90% by mass or more, more preferably 95% by mass or more, and still more preferably 97% by mass or more.

In the case where a melamine compound is selected as the crosslinking agent, the resin composition may further contain an acid catalyst. By using the acid catalyst, the crosslinking reactivity of the polyolefin resin with the melamine compound can be improved. The acid catalyst is not particularly limited, and one can be properly selected among conventionally known acid catalysts and used. As such an acid catalyst, for example, organic acid catalysts, such as p-toluenesulfonic acid, methanesulfonic acid, and an alkyl phosphoric acid ester, are suitable.

The acid catalyst may be used alone, or may be used in combination of two or more thereof. In addition, its use amount is preferably 0.1 to 15 parts by mass, more preferably 0.5 to 10 parts by mass, and still more preferably 1 to 5 parts by mass based on 100 parts by mass of the polyolefin resin.

Taking into consideration convenience on use and so on, the resin composition is preferably used in a mode of a solution containing an organic solvent. As the organic solvent, one can be properly selected among known organic solvents having favorable solubility in the polyolefin resin and used. Examples of such an organic solvent include toluene, xylene, heptane, octane, methanol, ethanol, isopropyl alcohol, isobutanol, n-butanol, ethyl acetate, acetone, methyl ethyl ketone, cyclohexanone, and tetrahydrofuran. These may be used alone, or may be used in combination of two or more thereof.

The amount of the organic solvent may be properly selected such that the resin composition containing the polyolefin resin and the crosslinking agent has an appropriate viscosity at the time of coating.

Although the amount of a solid contained in the solution of the resin composition is not particularly limited, it is preferred to control the content of a solid in a range of preferably 0.1 to 15% by mass, more preferably 0.2 to 10% by mass, and still more preferably 0.5 to 5% by mass in terms of a solid concentration relative to the whole amount of the resin composition.

The resin composition may contain various additives, such as an antioxidant, a ultraviolet absorber, an inorganic or organic filler, an antistatic agent, a surfactant, a photoinitiator, and a photostabilizer, as the need arises.

The release sheet of the present invention can be, for example, produced by coating the resin composition containing the polyolefin resin and the crosslinking agent, or a solution thereof, on at least one surface of a substrate and then performing a heat treatment to crosslink the polyolefin resin with the crosslinking agent, thereby forming a crosslinked product (release layer).

A heat treatment temperature is preferably 100 to 170° C., and more preferably 130 to 160° C. In addition, though a heat treatment time is not particularly limited, it is preferably 30 seconds to 5 minutes.

Examples of a coating method of the resin composition include a gravure coating method, a bar coating method, a spray coating method, a spin coating method, an air knife coating method, a roll coating method, a blade coating method, a gate roll coating method, and a die coating method.

As for a thickness of the coating of the resin composition, it is preferred to perform coating such that a thickness of the resulting release layer is preferably 25 to 1,000 nm, and more preferably 50 to 500 nm. By performing the coating such that the thickness of the release layer is 25 nm or more, the desired easy peeling property can be obtained, and by performing the coating such that the thickness of the release layer is 1,000 nm or less, curing properties can be made favorable.

The release layer which is used for the release sheet of the present invention is constituted of a material not substantially containing a silicone compound. In this specification, the wording “not substantially containing a silicone compound” refers to the matter that the amount of Si in the release layer is less than 0.1% by mass in the elementary analysis. In the release sheet of the present invention, the release layer is constituted of a material not substantially containing a silicone compound, and therefore, the silicone compound does not migrate into various materials, such as a pressure sensitive adhesive sheet and a resin sheet, to be laminated on the release layer. For that reason, in the case of using the release sheet of the present invention for precision applications, such as an electronic component, neither corrosion nor malfunction of the electronic component, etc. is caused.

### (Substrate)

Examples of the substrate which is used for the release sheet of the present invention include papers, such as a wood-free paper, a clay-coated paper, a cast-coated paper, and a craft paper; paper sheets, such as a laminated paper having such a paper laminated with a thermoplastic resin, such as a polyethylene resin, and a synthetic paper; and sheets of a synthetic resin, such as a polyolefin resin, e.g., a polyethylene resin and a polypropylene resin, a polyester resin, e.g., a polybutylene terephthalate resin, a polyethylene terephthalate resin, and a polyethylene naphthalate resin, a polyether imide resin, an acetate resin, a polystyrene resin, and a vinyl chloride resin. The substrate may be a single layer, or may be a multi-layer of two or more layers made of the same or different kind thereof.

Although a thickness of the substrate is not particularly limited, it may be typically 10 to 300 μm, and preferably 20 to 200 μm. When the thickness of the substrate is 10 to 300 μm, a pressure sensitive adhesive sheet using the release sheet can be given resiliency or strength suited for applying processing, such as printing, cutting, and sticking.

In the case of using a synthetic resin as the substrate, a surface of the substrate on which the release layer is provided can be subjected to a surface treatment by a method, such as an oxidation method and an asperity formation method according to a desire, for the purpose of improving adhesiveness between the substrate and the release layer. Examples of the oxidation method include a corona discharge surface treatment, a chromic acid surface treatment (wet type), a flame surface treatment, a hot air surface treatment, and an ozone-ultraviolet irradiation surface treatment. Examples of the asperity formation method include a sand blast method and a solvent treatment method. Although these surface treatment methods are properly selected according to the kind of the substrate, in general, the corona discharge surface treatment method is preferably adopted from the viewpoints of effects and operability. In addition, a primer treatment can also be applied.

The release sheet of the present invention may be subjected to an emboss processing on the surface thereof on the release layer side, to form asperities on the surface of the release sheet.

In the release sheet of the present invention, other layer, such as a primer layer and an antistatic layer, may be provided between the substrate and the release layer. In view of the fact that the release sheet includes a primer layer, dropping of the release layer from the release sheet can be effectively prevented from occurring.

The primer layer is typically formed by coating a primer coating agent on the surface of the substrate on the release layer side. Examples of the primer coating agent include a polyester-based resin, a urethane-based resin, an acrylic resin, a melamine-based resin, an oxazoline group-containing resin, a carbodiimide group-containing resin, an epoxy group-containing resin, an isocyanate-containing resin, and copolymers thereof, and a coating agent composed mainly of a natural rubber or a synthetic rubber. These resins may be used alone, or may be used in combination of different two kinds thereof. In order to improve coating properties of the primer coating agent onto the surface of the substrate and adhesiveness between the substrate and the primer layer, a surface treatment, such as a chemical treatment and a discharge treatment, may be applied on the surface of the substrate on which the primer coating agent is coated.

A thickness of the primer layer is preferably 50 nm or more, and more preferably 100 nm or more. In addition, the foregoing thickness is preferably 5 μm or less, and more preferably 1 μm or less. In view of the fact that the foregoing thickness is 50 nm or more, the effect of the primer layer can be favorably obtained. In addition, in view of the fact that the foregoing thickness is 5 μm or less, the slipperiness of the surface of the primer layer on the opposite side to the substrate becomes favorable, and the workability for coating the release agent composition on the primer layer become favorable.

The back migration amount of the release sheet of the present invention can be calculated by measuring an element mass ratio (analytical elements: C and O) of the material (polyester film) to be used upon being superimposed on the release layer by using an X-ray photoelectron spectroscopy (XPS) device. Specifically, by measuring the element mass ratio (analytical elements: C and O) by a method described in the section of Examples as mentioned later, the back migration amount of the release sheet can be calculated.

The back migration amount of the release sheet of the present invention can be set to preferably less than 0.10%, and more preferably 0.08% or less.

In the release sheet of the present invention, a contact angle of water with respect to the surface of the release layer is preferably 115° or less, more preferably 110° or less, and still more preferably 105° or less. In addition, a contact angle of cyclohexanone with respect to the surface of the release layer is preferably 30° or less, more preferably 20° or less, and still more preferably 15° or less. Furthermore, a contact angle of N,N-dimethyl formaldehyde (DMF) with respect to the surface of the release layer is preferably 50° or less, more preferably 45° or less, and still more preferably 40° or less.

By controlling the contact angle of water to 115° or less, the contact angle of cyclohexanone to 30° or less, and the contact angle of DMF to 50° or less, respectively with respect to the surface of the release layer, for example, on the occasion of forming a pressure sensitive adhesive layer or a resin sheet, or the like on the release layer, the coating properties of the coating solution on the release layer can be improved.

The contact angle can be determined by measuring a contact angle of each of water, cyclohexanone, and DMF using a contact angle measuring device (for example, an automatic contact angle meter “DM-701”, manufactured by Kyowa Interface Science, Inc.) by the θ/2 method. Specifically, the contact angle can be determined by a method described in the section of Examples as mentioned later.

The release sheet of the present invention can be used as pressure sensitive adhesive sheets and so on, or protective sheets of various pressure sensitive adhesive bodies, and for example, it is used upon being stuck on a surface on the side of a pressure sensitive adhesive layer of a pressure sensitive adhesive sheet including the substrate and the pressure sensitive adhesive layer provided on one surface of the substrate. In addition, the release sheet of the present invention can also be used as a casting film when preparing various resin sheets, ceramic green sheets, synthetic leathers, various composite materials, and so on. In the case of being used as a casting film, the release sheet of the present invention is used in a step of releasing a sheet material of every kind formed through casting or coating, or the like of a resin, a ceramic slurry, etc. on the surface of the release sheet on the release layer side, from the release sheet. In addition, the release sheet of the present invention is preferably used for electronic devices, and for example, in a manufacturing process of an electronic component, such as a relay, a switch of every kind, a connector, a motor, and a hard disk, the release sheet of the present invention can be suitably used as a release sheet for use of pressure sensitive adhesive sheets of temporal tacking at the time of assembling of an electronic component, content indication of a component, and so on.

In the case where the release sheet is used for a pressure sensitive adhesive body including a pressure sensitive adhesive layer, such as a pressure sensitive adhesive sheet, a release force of the release layer from the pressure sensitive adhesive layer is preferably 2,000 mN/20 mm or less, more preferably 200 to 1,800 mN/20 mm, still more preferably 300 to 1,500 mN/20 mm, and yet still more preferably 500 to 1,000 mN/20 mm. By controlling the release force to 2,000 mN/20 mm or less, the desired release properties can be obtained in a release sheet not using a silicone-based release agent.

The release force can be measured by a method described in the section of Examples as mentioned later.

Examples of the pressure sensitive adhesive constituting the pressure sensitive adhesive layer include an acrylic pressure sensitive adhesive.

### EXAMPLES

The present invention is hereunder specifically described by reference to Examples and Comparative Examples. But, it should be construed that the present invention is not limited to the embodiments described in the Examples.

The release sheets prepared in Examples and Comparative Examples described below were evaluated according to the following methods.

### 1. Evaluation of Thickness of Release Layer

A thickness of the release layer of the obtained release sheet was measured with a spectroscopic ellipsometer (a trade name: “Spectroscopic Ellipsometry 2000U”, manufactured by J.A. Woollam Japan Corporation).

### 2. Evaluation of Solvent Resistance

On the release layer of the obtained release sheet, a non-woven fabric (a trade name: BEMCOT, manufactured by Asahi Kasei Corporation) having methyl ethyl ketone impregnated therewith was placed and wiped away five times while applying a load of 100 g from above. The surface of the release layer was observed through visual inspection, and the case where no change was observed on the surface of the release layer was evaluated as “A”, whereas the case where the surface of the release layer was whitened due to a scratch, etc. was evaluated as “C”.

### 3. Evaluation of Release Force

On the release layer of the obtained release sheet, a polyester pressure sensitive adhesive tape having a width of 20 mm (a product number: No. 31B, manufactured by Nitto Denko Corporation) was stuck by using a 5-kg roller, to prepare a pressure sensitive adhesive sheet. 30 minutes after sticking, the resulting pressure sensitive adhesive sheet was fixed in a universal tensile testing machine (a trade name: AUTOGRAPH AGS-20NX, manufactured by Shimadzu Corporation), and the release layer was released from the pressure sensitive adhesive sheet toward the 180° direction at a drawing rate of 0.3 m/min in conformity with JIS K6854:1999, thereby measuring a release force (mN/20 mm) of the release sheet.

### 4. Evaluation of Back Migration Amount

A polyethylene terephthalate (PET) film having a thickness of 50 μm (a trade name: DIAFOIL (registered trademark) T-100, manufactured by Mitsubishi Plastics, Inc.; hereinafter referred to as “evaluation PET”) was prepared, and the surface of the evaluation PET was measured for an element mass ratio (analytical elements: C and O) by using an X-ray photoelectron spectroscopy device (a trade name; PHI Quantera II, manufactured by ULVAC-PHI, Inc.).

Subsequently, the evaluation PET was superimposed on the release layer of the release sheet prepared in each of the Examples and Comparative Examples to prepare a laminated sample, which was then pressurized at 10 kg/cm² and allowed to stand for 24 hours. Thereafter, the release sheet was removed from the laminated sample, and the surface of the evaluation PET with which the release layer of the release sheet had come into contact was measured for an element mass ratio (analytical elements: C and O) by means of XPS. From a C element ratio between the evaluation PET before lamination and the evaluation PET after lamination, an increase (%) of the C element ratio was determined according to the following equations, and this was defined as a back migration amount.

[C element ratio]=(Measured value of C element amount)/[(Measured value of C element amount)+(Measured value of O element amount)]

Migration amount (%)=[(C element ratio after lamination)−(C element ratio before lamination)]/(C element ratio before lamination)×100

### 5. Evaluation of Contact Angle

A contact angle of 2 μL of each of solvents (water, cyclohexanone, and N,N-dimethyl formaldehyde (DMF)) on the surface of the release layer of the obtained release sheet was measured with an automatic contact angle meter “DM-701”, manufactured by Kyowa Interface Science, Inc. Specifically, the release sheet was rested on a flat glass substrate at an inclination of 0° in an environment at a temperature of 23° C. and a humidity of 50%, 2 μL of water (purified water, manufactured by Kyoei Pharmaceutical Co., Ltd.) was dropped on the surface of the release layer of the release sheet, and 3 seconds after the liquid drop rested, the contact angle was measured according to the θ/2 method. An average value obtained by measuring 5 times was defined as a value of the contact angle. With respect to cyclohexanone (a special grade, manufactured by Shoei Chemical Co., Ltd.) and DMF (a special grade, manufactured by Shoei Chemical Co., Ltd.), the respective contact angles were also determined in the same manner.

### Example 1

To 100 parts by mass (88% by mass relative to the whole amount of a resin composition for release layer) of a hydrogenated product of polyisoprene having a hydroxy group on both terminals thereof (a trade name: EPOL (registered trademark), manufactured by Idemitsu Kosan Co., Ltd., solid concentration: 100% by mass, number average molecular weight 2,500), 14.1 parts by mass (10% by mass relative to the whole amount of a resin composition for release layer) of a methylated melamine resin (a trade name: TESFINE (registered trademark) 200, manufactured by Hitachi Kasei Polymer Co., Ltd., solid concentration: 80% by mass, diluent solvent: isobutanol/toluene=1/1) as a crosslinking agent and 2 parts by mass of p-toluenesulfonic acid as an acid catalyst were added to prepare a resin composition for release layer. This resin composition for release layer was diluted with a solvent (toluene/methyl ethyl ketone=6/4 (mass ratio)) to prepare a coating solution having a solid concentration of 1.5% by mass. The prepared coating solution was coated on one surface of a polyethylene terephthalate (PET) film having a thickness of 50 nm (a trade name: DIAFOIL (registered trademark) T-100, manufactured by Mitsubishi Plastics, Inc.) by using a Meyer bar, such that its film thickness after drying was 100 nm, thereby forming a coating film. The coating film was cured upon drying at 150° C. for 1 minute to form a release layer, thereby obtaining a release sheet.

### Example 2

A release sheet was obtained in the same manner as in Example 1, except that the coating solution was coated on one surface of the PET film, such that its film thickness after drying was 500 nm.

### Example 3

A release sheet was obtained in the same manner as in Example 1, except that the amount of the hydrogenated product of polyisoprene having a hydroxy group on both terminals thereof was changed to 64% by mass, and the amount of the methylated melamine resin was changed to 35% by mass, relative to the whole amount of the resin composition for release layer.

### Example 4

To 100 parts by mass of a solution of a mixture of 80 parts by mass of a bisphenol A type epoxy resin ester and 20 parts by mass of a melamine resin as a crosslinking agent (a trade name: TA31-059D, manufactured by Hitachi Kasei Polymer Co., Ltd.), 2.5 parts by mass of a methanol solution of p-toluenesulfonic acid as an acid catalyst was added to prepare a solution of a primer coating agent.

The prepared coating solution of a primer coating agent was coated on one surface of a polyethylene terephthalate (PET) film having a thickness of 50 nm (a trade name: DIAFOIL (registered trademark) T-100, manufactured by Mitsubishi Plastics, Inc.) by using a bar coater, thereby forming a coating film. The coating film was cured upon drying at 140° C. for 1 minute to form a primer coating layer having a thickness of 50 nm. There was thus obtained a laminate of a substrate and a primer layer.

Subsequently, the coating solution of the resin composition for release layer prepared in Example 1 was coated on a surface of the primer layer on the opposite side to the substrate in the laminate, such that its film thickness after drying was 100 nm, thereby forming a coating film. The coating film was cured upon drying at 145° C. for 1 minute to form a release layer. There was thus obtained a release sheet.

### Comparative Example 1

A release sheet was obtained in the same manner as in Example 1, except that the amount of the hydrogenated product of polyisoprene having a hydroxy group on both terminals thereof was changed to 93% by mass, and the amount of the methylated melamine resin was changed to 5% by mass, relative to the whole amount of the resin composition for release layer.

### Comparative Example 2

A non-functional polybutadiene resin (a trade name: JSR BR01, manufactured by JSR Corporation, solid concentration: 100% by mass) was diluted with heptane such that its solid concentration was 0.25% by mass, thereby preparing a coating solution. The prepared coating solution was coated on one surface of a polyethylene terephthalate (PET) film having a thickness of 50 μm (a trade name: DIAFOIL (registered trademark) T-100, manufactured by Mitsubishi Plastics, Inc.) by using a Meyer bar, such that its film thickness after drying was 50 nm, dried at 150° C. for 1 minute, and then irradiated with ultraviolet rays (25 mJ/cm²) to cure the coating solution, thereby forming a release layer. There was thus obtained a release sheet.

TABLE 1

| | | Relative to the whole amount | | | | | | | | |
|---|---|---|---|---|---|---|---|---|---|---|
| | | of resin composition | | | | | | | | |
| | | Amount of | Amount of | | | | | | | |
| | | polyolefin resin | non-functional | Amount of | | | | | | Back |
| | Thickness of | having a reactive | polybutadiene | crosslinking | | Release | | | | migration |
| | release layer | functional group | resin | agent | Solvent | force | Contact angle [°] | | | amount |
| | [nm] | [mass %] | [mass %] | [mass %] | resistance | [mN/20 mm] | Water | Cyclohexanone | DMF | [%] |
| Example 1 | 100 | 88 | — | 10 | A | 860 | 100.3 | 13.8 | 37.2 | 0.08 |
| Example 2 | 500 | 88 | — | 10 | A | 670 | 100.8 | 14.4 | 36.2 | 0.05 |
| Example 3 | 100 | 64 | — | 35 | A | 1740 | 101.0 | 8.7 | 34.3 | 0.02 |
| Example 4 | 100 | 88 | — | 10 | A | 860 | 100.3 | 13.8 | 37.2 | 0.08 |
| Comparative | 100 | 93 | — | 5 | C | 400 | 100.8 | 13.8 | 36.8 | 0.10 |
| Example 1 | | | | | | | | | | |
| Comparative | 50 | — | 100 | — | C | 1500 | 93.6 | 7.7 | 22.4 | 25.3 |
| Example 2 | | | | | | | | | | |

### CONCLUSION OF RESULTS

In Examples 1 to 4 in which the release layer was formed by using the resin composition containing the polyolefin resin having a reactive functional group and the crosslinking agent in specified proportions, respectively, there were obtained the results such that not only the solvent resistance is excellent, but also the back migration amount of from the release layer into the PET film is small as 0.02 to 0.08%. On the other hand, in Comparative Example 1 in which the amount of the crosslinking agent is smaller than the range of the present invention, the polyolefin resin having a reactive functional group and the crosslinking agent cannot be thoroughly crosslinked with each other, and therefore, the solvent resistance was not obtained, and the surface of the release layer was whitened due to a scratch, etc. In addition, in Comparative Example 2 in which the release layer was formed by using the polybutadiene resin not having a reactive functional group, the back migration amount was high as 25.3%, the solvent resistance was not obtained, and the surface of the release layer was whitened due to a scratch, etc.

### REFERENCE SIGNS LIST

10: Release sheet
1: Substrate
2: Release layer

1: A release sheet, comprising:
a substrate and
a release layer,
wherein
the release layer comprises a crosslinked product of a resin composition containing a polyolefin resin having a reactive functional group and a crosslinking agent; and
a content of the polyolefin resin is from 50 to 90% by mass, and a content of the crosslinking agent is from 7 to 45% by mass, relative to a total amount of the resin composition.

2: The release sheet according to claim 1, wherein the release layer is provided on the substrate.

3: The release sheet according to claim 1, wherein the reactive functional group in the polyolefin resin is a hydroxyl group.

4: The release sheet according to claim 1, wherein the polyolefin resin has the reactive functional group on both terminals thereof.

5: The release sheet according to claim 1, wherein the polyolefin resin is a hydrogenated product of polyisoprene.

6: The release sheet according to claim 1, wherein a number average molecular weight of the polyolefin resin is from 1,500 to 30,000.

7: The release sheet according to claim 1, wherein the crosslinking agent is a melamine compound.

8: The release sheet according to claim 7, wherein the melamine compound is at least one selected from the group consisting of a methylolated melamine resin, an iminomethylolated melamine resin, a methylated melamine resin, an ethylated melamine resin, a propylated melamine resin, a butylated melamine resin, a hexylated melamine resin, and an octylated melamine resin.
